(19) United States
(12) Patent Application Publication
(10) Pub. No.: US 2002/0164087 A1
(43) Pub. Date: Nov. 7, 2002

(54) System and method for fast rotation of binary images using block matching method

(76) Inventors: Sung Chien II, Daegu (KR); Yung Mok Baek, Daegeon (KR); In Cheol Kim, Daegu (KR)

Correspondence Address: HARNESS, DICKEY & PIERCE, P.L.C., P.O. BOX 828, BLOOMFIELD HILLS, MI, 48303, US

(21) Appl. No.: 10/087,358

(22) Filed: Feb. 28, 2002

(30) Foreign Application Priority Data
Apr. 13, 2001 (KR) 2001-19811

(51) Int. Cl. G06K 9/36

(52) U.S. Cl. 382/289

(57) ABSTRACT

Disclosed is a system and method for fast rotation of an original image having a skew angle. The image rotation system includes a PMP generation unit for generating PMPs with respect to bit patterns of a block, and a buffer for storing the PMPs. The system further includes an image division unit for dividing the original image to blocks, a bit pattern extraction unit for extracting the bit patterns for the blocks, a PMP address generation unit for calculating addresses of the buffer for storing the corresponding PMPs with respect to the bit patterns, and an output unit for fetching and outputting the PMPs from the addresses onto an output plane.

### BACKGROUND OF THE INVENTION

1. Field of the Invention

The present invention relates to an image processing system, and more particularly, to a system for fast rotation of binary images using a block matching method with the prevention of hole generation and topology variation usually occurring in rotation.

2. Description of the Related Art

A fast rotation algorithm for a binary image is essential in various image processing applications. In particular, to detect and correct a skew angle is an important stage in document image processing and analysis systems, since it is quite probable that the document may be misaligned during the scanning process. Such skewness may cause problems in subsequent procedures of layout analysis and character recognition. FIG. 1 illustrates a system for inputting and correcting the skew images.

Referring to FIG. 1, at first, a binary image 100 of a document, a picture or a fingerprint is inputted through an input device 110 such as a scanner, a camera or a fingerprint input device. If the binary images inputted through the input device 110 have a skew angle, they are corrected using an image rotation system 130. The corrected binary images 140 are used for analysis in an image analysis system 150.

The image rotation system 130 detects a skew angle of an original binary image and corrects the image. To detect the skew angle and to correct the skew image are important stages in the image processing and analysis system.

The first step of correcting the skew image is to detect a skew angle, and for this, several methods have been developed by researchers. However, since the detailed description thereof is beyond the scope of the present invention, we briefly summarize the typical approaches that attract our attention.

For example, Hashizume et al., “A method of detecting the orientation of aligned components”, Pattern Recognition Letters, Vol. 4, pp. 125-132(1986), have detected a skew angle by the nearest neighbor clustering of the connected components.

lso, Jiang et al., “A fast approach to the detection and correction of skew documents”, Pattern Recognition Letters, Vol. 18, pp. 675-686(1997), have proposed Hough transform based methods that relate the Hough plane peaks to the estimated skew angle. Avanindra et al., “Robust detection of skew in documented images”, IEEE Trans. Image Processing, Vol. 6, pp.344-349, February 1997, have proposed robust detection of skew by using interline cross-correlation in the scanned image. There are also other methods for detecting document skew based on Fourier transform and morphological transform.

After detecting a skew angle by such methods for detecting the skew angle, each pixel in a skew image will be rotated to correct the skew image. If the skew image has a huge size, a very fast rotation method is quite demanded to make the document processing system more practical and valuable.

The speed of rotation is one of the most important factors for evaluating rotation algorithms, but the quality of the rotated image is also quite serious for some applications. When the skew image is rotated by the conventional rotation methods, empty spots or holes are generated in the rotated image because some pixels perform many-to-one mapping and one connected component is split into two separated components after rotation. Such hole generation and topology variation are the important factors for decreasing the image quality.

Several algorithms are mostly suitable for rotating binary images. A simple method of eliminating the hole is an inverse mapping method in which the pixel value of a rotated image buffer is determined by mapping inversely every point of the rotated image buffer to the original image buffer. The inverse mapping method is performed slowly, and thus this method is not practical in processing a huge image.

Recently, Jiang et al., “A fast approach to the detection and correction of skew documents”, Pattern Recognition Letters, Vol. 18, pp. 675-686(1997), have used the mapping table, which is obtained in advance from the skew angle to speed up the inverse mapping process. Though this method transforms 16 pixels at one time, topology preservation cannot be confirmed.

Also, A. W. Paeth, “A fast algorithm for general raster rotation”, in Proc. Graphics Interface 86, pp. 77-81(1986), have proposed a 3-pass algorithm in the context of computer graphics, in which the rotation matrix is decomposed into three shearing matrices. However, this method can remove holes but it is generally slower than the general methods and cannot preserve topology.

Cheng et al., “Parallel image transformation and its VLSI implementation”, Pattern Recognition, Vol. 23, pp. 1113-1129(1990) observed that holes can appear when the distance between the rotated points is 2 or √5, and proposed that midpoints be filled to eliminate holes and confirm the connectedness of a region. However, this method needs calculation of not only coordinate mapping but also distance between two rotated pixels and thus requires longer processing time.

### SUMMARY OF THE INVENTION

Accordingly, the present invention solves the problems of the related art. Therefore, it is an object of the invention to provide a method for fast rotation of a skew image.

It is another object of the invention to provide a method for fast rotation of a skew image with the prevention of hole generation and topology variation after rotation.

In one aspect of the invention, there is provided a method of fast rotating an original image having a skew angle. The method includes the steps of (a) generating predrawn mapping patterns(PMPs) with respect to all bit patterns of a block having a predetermined size by rotating the bit pattern using the skew angle, (b) storing the PMPs in a buffer, (c) dividing the original image into blocks, having the predetermined size, (d) extracting the bit patterns of the blocks, and (e) fetching the PMPs with respect to the bit patterns and outputting the fetched PMPs onto an output plane.

Preferably, the original image includes one of a binary image and a halftone image. Also, addresses of the buffer for storing the PMPs are obtained by shifting and OR gating the corresponding bit patterns. Additionally, the step (c) divides the original image into the blocks, so that the blocks overlap one another by one pixel horizontally and vertically.

In another aspect of the invention, there is provided a method of rotating an original image having a skew angle. The method includes the steps of (a) generating PMP M_{black} with respect to a coarse block composed of black pixels and PMPs with respect to bit patterns of a fine block, (b) storing the PMPs with respect to all the bit patterns of the fine block and the PMP M_{black} with respect to the coarse block composed of the black pixels, (c) dividing the original image into coarse blocks and detecting whether the coarse block is composed of the black pixels, and (d) if the coarse block is composed of the black pixels, fetching the PMP M_{black} and outputting the PMP M_{black} onto a output plane, while if not, dividing the coarse block into fine blocks, fetching the PMPs with respect to the bit patterns of the fine blocks, and outputting the fetched PMPs onto the output plane.

Preferably, the coarse block is composed of 9×9 pixels, and the fine coarse block is composed of 3×3 pixels. Also, the step (c) divides the original image into coarse blocks so that the coarse blocks overlap one another one pixel horizontally and vertically, and the step (d) divides the coarse block into the fine blocks so that the fine blocks overlap by one pixel horizontally and vertically.

In still another aspect of the invention, there is provided a system for correcting an original image having a skew angle. The system includes a skew angle estimation unit for estimating the skew angle of a skewed image, a PMP generation unit for generating predrawn mapping patterns with respect to bit patterns of a block using the skew angle, means for storing the predrawn mapping patterns generated by the PMP generation unit, an image division unit for dividing the original image into blocks of a predetermined size, a bit pattern extraction unit for extracting the bit patterns of the blocks, and an output unit for fetching the PMPs with respect to the bit patterns extracted by the bit pattern extraction unit and outputting the fetched PMPs onto an output plane.

Preferably, the output unit includes a PMP address unit for calculating addresses for storing the PMPs corresponding to the bit patterns of the blocks in said means for storing the PMPs, and a PMP output unit for outputting the PMPs onto the output plane whose coordinates are calculated by rotating upper-left coordinates of the block using the skew angle.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

FIG. 1 is a schematic view of a system for inputting and correcting a skew image according to the present invention.

FIG. 2 is a block diagram illustrating the construction of an image rotation system according to the present invention.

FIG. 3 is a flowchart illustrating the operation the image rotation system according to a first embodiment of the present invention.

FIG. 4 is a view explaining the method of determining addresses of a memory according to the present invention.

FIG. 5 is a view explaining the method for fast rotation of a skew image according to the present invention.

FIG. 6 is a flowchart illustrating the operation of the image rotation system according to a second embodiment of the present invention.

FIGS. 7 and 8 are views explaining the quality of the rotated image according to the present invention.

FIGS. 9 and 10 are graphs showing the performance of the method according to the present invention.

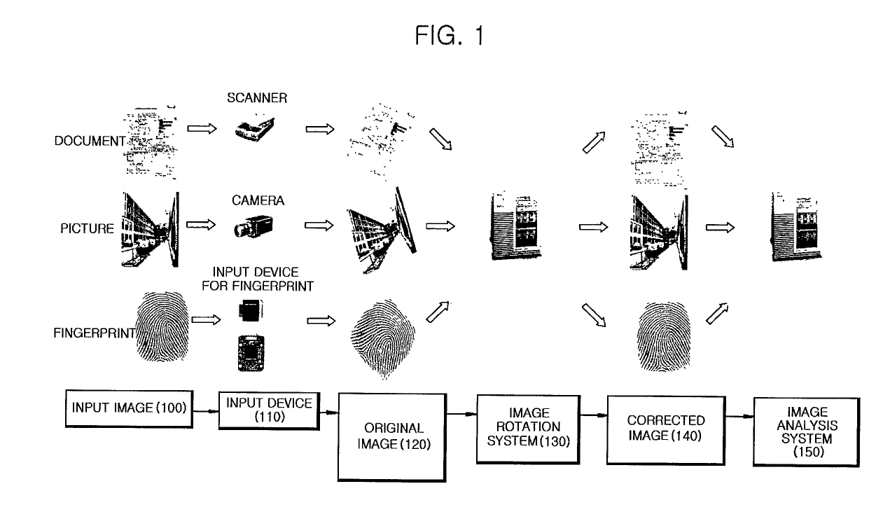

### DETAILED DESCRIPTION OF THE PREFERRED EMBODIMENTS

Hereinafter, a detailed description will be provided about the configuration and operation of the image rotation system according to the present invention in reference with accompanying drawings.

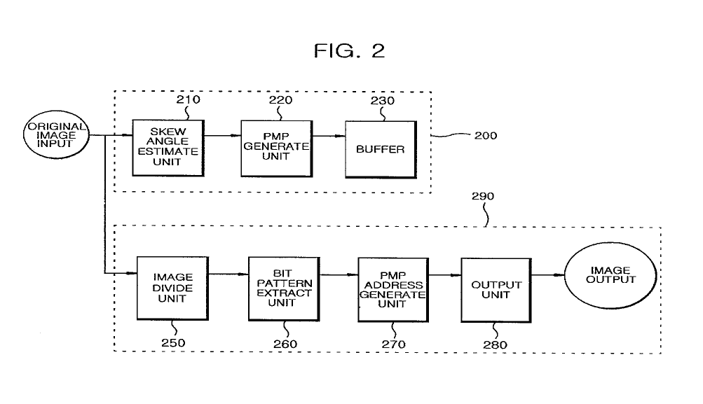

FIG. 2 is a block diagram showing the image rotation system using a block matching method according to the present invention. A description will be provided about the configuration and operation of the image rotation system according to the invention in reference to FIG. 2.

As shown in FIG. 2, the image rotation system of the invention includes of a preprocessing device 200 and a PMP mapping device 290.

The preprocessing device 200 is comprised of a skew estimation unit 210, a PMP generation unit 220, and a buffer 230. The preprocessing device 200 detects a skew angle, rotates all the bit patterns using the skew angle in advance, and then stores them in a buffer with their addresses. The rotated bit patterns are now defined as predrawn mapping patterns (PMPs), because the rotated bit patterns enable mapping of the whole pixels of a block onto the output plane at the same time.

First, an original image is inputted from a scanner, a camera or a finger printer input device. And then, if the original image inputted from the input device has a skewness, the skew estimation unit 210 detects a skew angle of the inputted original image.

The PMP generation unit 220 generates one PMP M_{black} for the coarse black composed of 9×9 pixels according to the skew angle detected by the skew estimate unit 210. The PMP M_{black} will be used for rotating the 9×9 homogeneous black region.

Also, the PMP generation unit 220 generates 512 PMPs Mₓs for a fine block composed of 3×3 pixels. The 512 PMPs Mₓs correspond to the bit pattern Pₓ of a fine block, and the index x represents an address of the PMPs for the chosen fine block. A 3×3 fine block has nine bits, and 512(=2⁹) bit patterns exist in a 3×3 fine block. The index x is obtained from converting 3×3 bit pattern to an integer by bit shifting and OR operation.

Hereinafter, a description about the operation of rotating the original image in the PMP generation unit 220 will be provided.

The inputted original image is a binary image which has two pixel values, i.e. f(x,y)=0 or 1 (i.e., 0 for white pixel and 1 for black pixel). Let P(x,y) be a point in the original image and P′(x′,y′) be the point in the rotated image buffer. Image rotation for each black pixel can be performed by the general method as follows:

f(x′, y′)=1

where

$$[ \begin{matrix}{x}^{′} \\ {y}^{′}\end{matrix} ] = [ \begin{matrix}cos θ & - sin θ \\ sin θ & cos θ\end{matrix} ] [ \begin{matrix}x \\ y\end{matrix} ]$$

When the Euclidean distance between the rotated pixels is 2 or √5, the midpoints are filled with black pixels to avoid hole generation and region splitting.

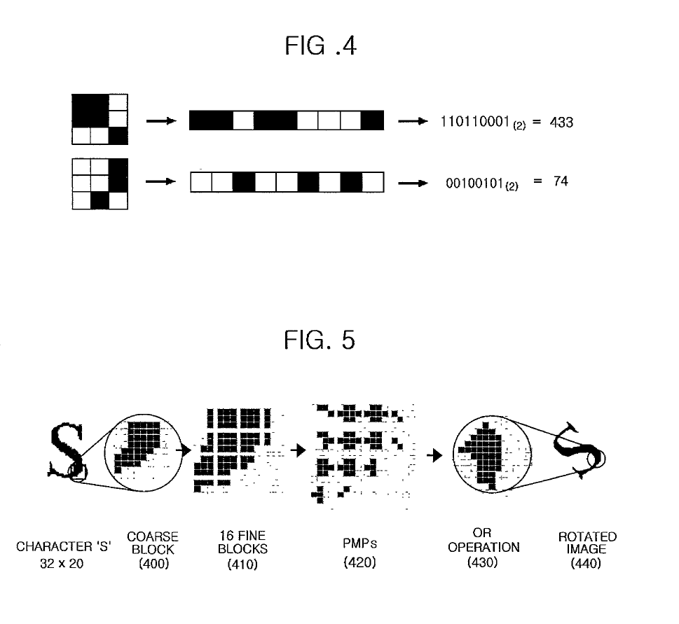

The buffer 230 stores the PMPs generated by the PMP generation unit 220. At this time, the addresses for storing the PMPs in the buffer 230 are determined according to the bit pattern. As shown in FIG. 4, the address for the specific bit pattern is obtained by shifting and OR operation.

The PMP mapping device 290 is comprised of an image division unit 250, a bit pattern extraction unit 260, a PMP address unit 270, and an output unit 280. The PMP mapping device 290 divides the original image into blocks, fetches the PMPs corresponding to the bit patterns of the blocks, and outputs the PMPs.

The image division unit 250 extracts a coarse block(CB) having 9×9 pixels on the entire original image and detects whether the coarse block is P_{black} or not. The P_{black} means the coarse block in which all pixels are black.

If the CB is P_{black}, an output coordinate for outputting the upper-left corner of the rotated CB is calculated by using the skew angle, and PMP M_{black} is drawn at the output coordinate. Then, the image division unit 250 moves to the next CB located 8 pixels apart from the previous CB. At this time, the coarse blocks are designed to overlap each other by 1-pixel horizontally and vertically to confirm inter-block connection and to avoid hole generation and topology variation.

If the CB is not P_{black}, then the CB is divided into fine blocks (FBs) composed of 3×3 pixels. For the same reason as overlapping the CBs, the image division unit 250 divides one CB into 16 FBs by making the FBs overlapping each other by one pixel horizontally and vertically. For each FB, its address Px is calculated and used to identify its PMP. Then, the address is fetched from the buffer 230 and overlaid onto the output plane at the corresponding position.

The bit pattern extraction unit 260 extracts bit patterns from the CB or the FB divided by the image division unit 250.

The PMP address unit 270 calculates the address in which the PMP corresponding to the bit pattern extracted from the bit pattern extraction unit 260 is stored.

The image output unit 280 fetches the PMP from the buffer 230 of which the address is calculated by the PMP address unit 270 and overlays at the corresponding coordinate onto the output plane. At this time, the new coordinate to output the PMP fetched from the buffer is obtained by rotating the coordinate of the upper-left corner of FB using the skew angle.

Then, the image output unit 280 outputs the PMPs fetched from the buffer 230 with respect to the 16 FBs consisting of the CB at the new coordinates. The individual FBs overlap each other by one pixel horizontally and vertically. So, the PMPs overlap each other by 1 pixel horizontally and vertically. And then, the image output unit 280 finally performs OR operations on those 16 PMPs at the 16 new coordinates.

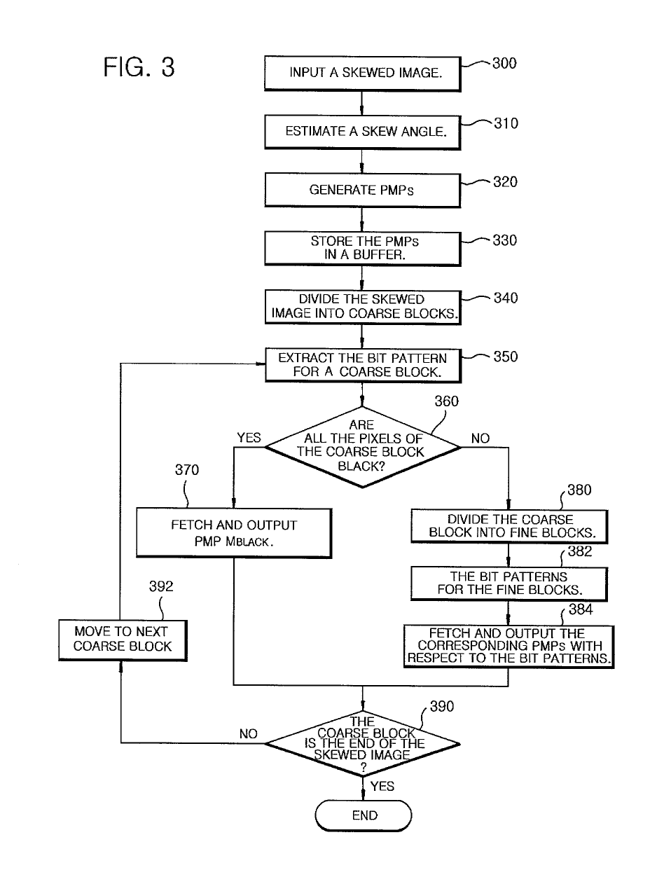

Hereinafter, a detailed description will be provided about the method of fast rotating the binary image according to the present invention with reference to FIG. 3.

First, the skew image is inputted (step 300), and the skew angle is estimated from the skew image (step 310). Then, using the skew angle, PMPs for all the bit patterns of FBs and PMP M_{black} for the CB in which all the pixels are black are generated and stored in the buffer (steps 320 and 330).

Then, a 9×9 CB is extracted from the skewed original image and a bit pattern with respect to the CB is extracted (step 350).

Then, it is detected whether all the pixels in the extracted bit pattern of the CB are black or not (step 360). If all the pixels of the CB are black, the PMP M_{black} is fetched from the buffer and outputted at the corresponding position (step 370).

If not, the CB is divided into 16 FBs (step 380), and all the bit patterns of the FBs are extracted (step 382). Then, PMPs corresponding to the bit patterns extracted from the FBs are fetched from the buffer and outputted at the corresponding position on the output plane (step 384).

Then, it is detected whether the CB is the last CB of the original image or not (step 390). If the CB is the last CB of the original image, the procedure is ended, while if not, it moves to the next CB and the procedure returns to step 350.

Hereinafter, a description will be provided about the procedure of an example of rotating the skew image with reference to FIG. 5.

As shown in FIG. 5, the portion of the character ‘S’ having 32×20 pixels is inputted, and then the bit pattern of a 9×9 CB 400 from the inputted character image is extracted.

Since all the pixels of the extracted CB are not black, the extracted CB is divided into 3×3 FBs 410 so that FBs overlap each other by one pixel horizontally and vertically. Therefore, one CB is divided into 16 FBs.

Then, PMPs 420 which correspond to the bit patterns of the divided FBs are fetched from the buffer and outputted at the output plane whose coordinates are calculated from the upper-left coordinates of the FBs using the skew angle. Then, the OR operations 430 are performed on the 16 PMPs at the 16 coordinates, and as a result the rotated image 440 can be obtained.

In another embodiment of the present invention, the coarse block is composed of 17×17 pixels and the fine block is composed of 4×4 pixels. Therefore, the PMPs should be predrawn as many as 2¹⁶(=65536). This embodiment needs a memory having a large size, but can perform the fast rotation of binary images.

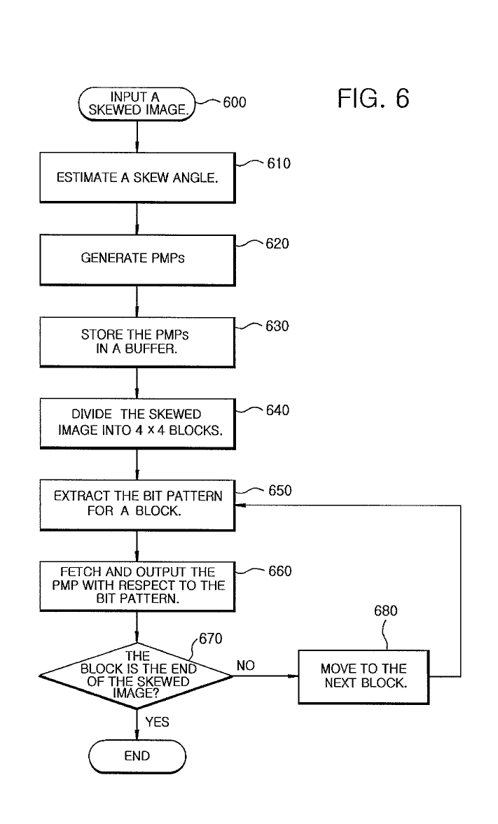

In still another embodiment of the present invention, the coarse block is not made and the fine block is composed of 4×4 pixels. Referring to FIG. 6, the operation will be described.

FIG. 6 is a flowchart showing the operation of the image rotation system according to the second embodiment of present invention.

First, a binary image is inputted (step 600) and the skew angle is estimated from the inputted binary image (step 610). Then, PMPs with respect to the bit patterns of a 4×4 block are generated (step 620), and the generated PMPs are stored in the buffer (step 630).

Then, the original image is divided into a 4×4 FB (step 640), and the bit patterns of the FBs are extracted (step 650). The PMPs corresponding to the bit patterns of the FBs are fetched from the buffer and outputted at the corresponding coordinates on the output plane (step 660).

Using the image rotation system according to the present invention, the best performance in terms of rotation speed is achieved. Also, the skew images can be rotated without the hole generation and the topology variation.

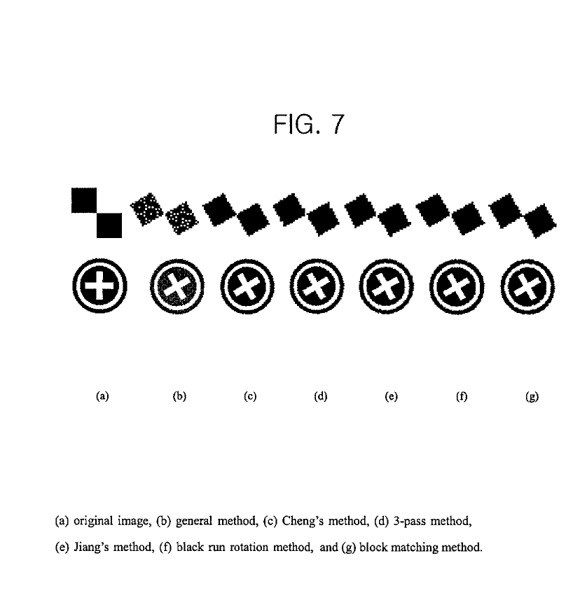

Referring to FIGS. 7 to 10, the effect of the present invention will now be described.

The FIG. 7 is a view showing the result of 30° rotation of two symbols using various rotation methods.

Referring to FIG. 7, (a) denotes an original image, and (b) to (g) respectively denote the rotated images using a general method, using Cheng's method, 3-pass method, Jiang's method, black run rotation method, and block matching method according to the present invention.

Rotation experiments have been made on the binary images of relatively simple objects. FIG. 7 includes the results of rotation using several rotation methods in order to compare the qualities of the rotated images.

As shown in FIG. 7, region split phenomena can be observed between the 8-connected pixels at the touching edge of the two rotated square blocks for general method, 3-pass method, Jiang's method, and black run rotation method.

Therefore, it is observed that the quality of the rotated image according to the present invention is similar to those of the rotated images according to the improved methods.

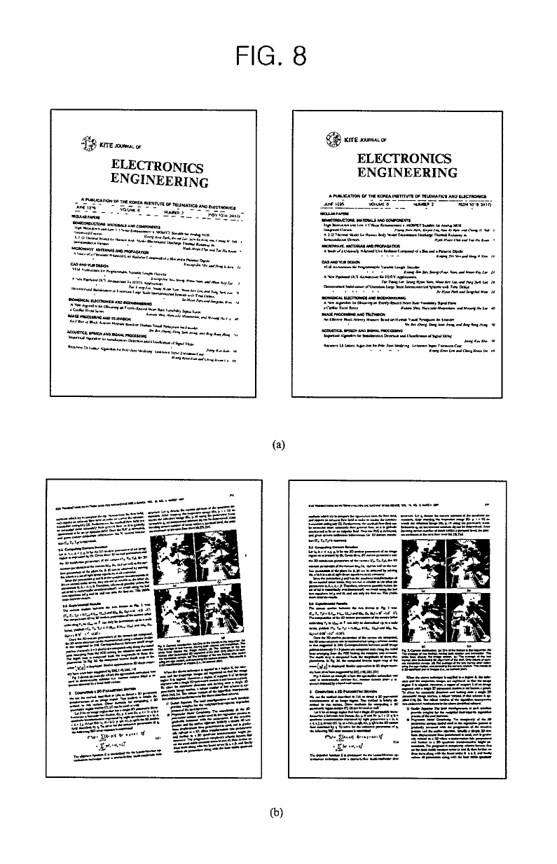

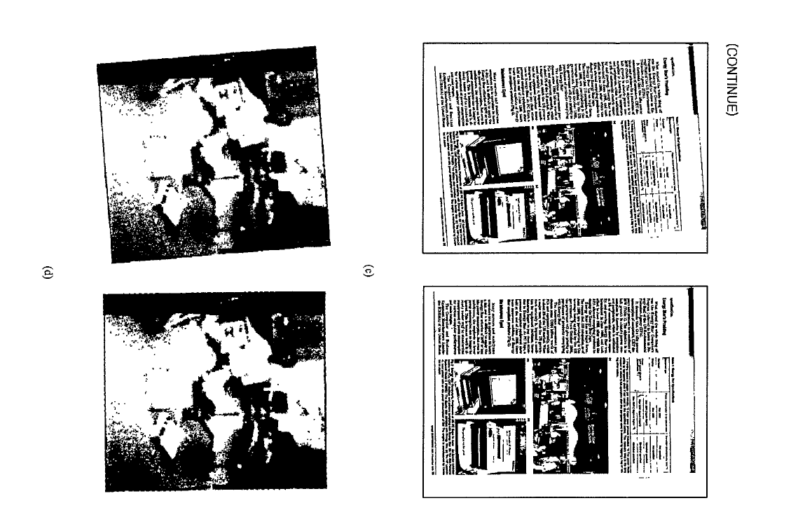

FIG. 8 shows rotation results of three A4 size images DOC1, DOC2, and DOC3 as shown as (a), (b), and (c), each scanned at 300 dpi, of which the black pixel densities are 0.05, 0.15, and 0.25, respectively. The DOC 1 image mostly consists of lines and characters, and has much less black pixel density than DOC 3 image containing large black graphic elements. To further clarify the image quality after rotation, one graphic element inside (b) is segmented out, enlarged, and displayed before and after rotation as indicated as (d) in FIG. 8.

When the quality of the rotated image according to the present invention is compared with that of the original image, it is convinced that they are similar to each other.

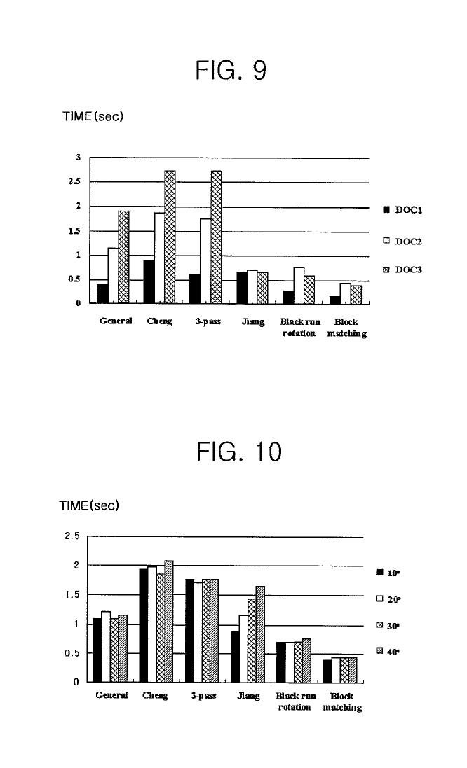

FIG. 9 shows the CPU times of six rotation methods needed to rotate DOC1, DOC2, and DOC 3 images, respectively. The CPU time includes the time for generating PMPs when measuring the processing time of the present invention. FIG. 9 shows that the CPU time for rotating an image is roughly proportional to the black density as expected for the general method, Cheng's method, and 3-pass method.

Through FIG. 9, it can be known that the CPU time of the block matching method according to the present invention is faster than those of other methods.

FIG. 10 shows the CPU times of six rotation methods with respect to four rotation angles for the DOC 2 image. Through FIG. 10, it can be known that the CPU times of the block matching method according to the present invention are faster than others, and vary scarcely with respect to the rotation angle.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method of rotating an original image having a skew angle, comprising the steps of:
(a) generating predrawn mapping patterns (PMPs) with respect to all bit patterns of a block having a predetermined size by rotating the bit pattern using the skew angle;
(b) storing the PMPs in a buffer;
(c) dividing the original image into blocks having the predetermined size;
(d) extracting the bit patterns of the blocks; and
(e) fetching the PMPs with respect to the bit patterns, and outputting the fetched PMPs onto an output plane.

2. The method according to claim 1, wherein the original image includes one of a binary image and a halftone image.

3. The method according to claim 1, wherein addresses of the buffer for storing the PMPs are obtained by shifting and OR-gating the corresponding bit patterns.

4. The method according to claim 1, wherein the step (c) divides the original image into the blocks so that the blocks overlap by one pixel horizontally and vertically.

5. A method of rotating an original image having a skew angle, comprising the steps of:
(a) generating predrawn mapping pattern (PMP M_{black}) with respect to a coarse block composed of black pixels and PMPs with respect to bit patterns of a fine block;
(b) storing the PMPs with respect to all the bit patterns of the fine block and the PMP M_{black} with respect to the coarse block composed of the black pixels;
(c) dividing the original image into coarse blocks, and detecting whether the coarse block is composed of the black pixels; and
(d) if the coarse block is composed of the black pixels, fetching the PMP M_{black} and outputting the PMP M_{black} onto an output plane, while if not, dividing the coarse block into fine blocks, fetching the PMPs with respect to the bit patterns of the fine blocks, and outputting the fetched PMPs onto the output plane.

6. The method according to claim 5, wherein the coarse block is composed of 9×9 pixels, and the fine coarse block is composed of 3×3 pixels.

7. The method according to claim 5, wherein the step (c) divides the original image into the coarse blocks so that the coarse blocks overlap one another by one pixel horizontally and vertically.

8. The method according to claim 5, wherein the step (d) divides the coarse block into the fine blocks so that the fine blocks overlap one another by one pixel horizontally and vertically.

9. The method according to claim 5, wherein addresses of the buffer for storing the PMPs are obtained by shifting and OR-gating the corresponding bit patterns.

10. A system for correcting an original image having a skew angle, comprising:
a skew angle estimation unit for estimating the skew angle of a skewed image;
a predrawn mapping pattern (PMP) generation unit for generating PMP with respect to bit patterns of a block using the skew angle;
means for storing the PMPs generated by the PMP generation unit;
an image division unit for dividing the original image into blocks of a predetermined size;
a bit pattern extraction unit for extracting the bit patterns of the blocks; and
an output unit for fetching the PMPs with respect to the bit patterns extracted by the bit pattern extraction unit, and outputting fetched PMPs onto an output plane.

11. The system according to claim 10, wherein the output unit includes:
a PMP address unit for calculating addresses for storing the PMPs corresponding to the bit patterns of the blocks in said means for storing the PMPs; and
a PMP output unit for outputting the PMPs onto the output plane whose coordinates are calculated by rotating upper-left coordinates of the block using the skew angle.

12. The system according to claim 11, wherein the PMP address unit calculates the addresses of the PMPs stored by the storing means by shifting and OR-gating the corresponding bit pattern.

13. The system according to claim 10, wherein the image division unit divides the original image into the blocks overlapping one another by one pixel horizontally and vertically.

14. A system for correcting an original image having a skew angle, comprising:
a skew angle estimation unit for estimating the skew angle of a skewed image;
a predrawn mapping patterns (PMP) generation unit for generating PMPs with respect to bit patterns of a fine block using the skew angle, and generating PMP M_{black} with respect to a coarse block composed of black pixels;
means for storing the PMPs and the PMP M_{black} generated by the PMP generation unit;
a image division unit for dividing the original image into coarse blocks, and dividing the coarse block into fine blocks;
a bit pattern extraction unit for extracting the bit patterns of the coarse blocks and fine blocks; and
an output unit for fetching the PMPs with respect to the bit patterns extracted by the bit pattern extraction unit, and outputting fetched PMPs onto an output plane.

15. The system according to claim 14, wherein if all pixels of the coarse block are black, the output unit fetches and outputs the PMP M_{black} with respect to the coarse block.

16. The system according to claim 14, wherein the image division unit divides the original image into the coarse blocks and the coarse block into fine blocks, the coarse blocks overlap one another by one pixel horizontally and vertically, and the fine blocks overlap one another by one pixel horizontally and vertically.
